(19) United States
(12) Patent Application Publication
(10) Pub. No.: US 2009/0189933 A1
(43) Pub. Date: Jul. 30, 2009

(54) Nozzle missing determining device for liquid ejecting apparatus , liquid ejecting apparatus, and method of determining nozzle missing

(75) Inventor: Kenichi Nakano, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/321,911

(22) Filed: Jan. 26, 2009

(30) Foreign Application Priority Data
Jan. 28, 2008 (JP) 2008-016456

(51) Int. Cl. B41J 29/38; B41J 29/393

(52) U.S. Cl. 347/9; 347/19

(57) ABSTRACT

A nozzle missing determining device that determines a nozzle missing state of a liquid ejecting apparatus, the nozzle missing determining device determines whether all the nozzles having predetermined positional relationship are non-ejection nozzles based on a test result data, the predetermined positional relationship includes positional relationship of nozzles of which dots that are formed by a same type of liquid are next to each other in accordance with the determined record mode.

### BACKGROUND

1. Technical Field

The present invention relates to a nozzle missing determining device in a liquid ejecting apparatus that determines a nozzle missing state by performing a test for detecting a non-ejection nozzle that cannot eject a liquid of a required amount due to nozzle clogging of a ejection unit or the like, a liquid ejecting apparatus, and a method of determining nozzle missing.

2. Related Art

Generally, in ink jet printers as liquid ejecting apparatuses of this type, by ejecting ink from nozzles disposed in a record head (ejection unit), a printing process for a target such as a paper sheet is performed. However, when the ink inside the nozzle has increased viscosity or air bubbles are mixed into the nozzle, a non-ejection nozzle that cannot eject ink is generated in the record head, and there is a problem such as dot missing in which a part of dots in a printed image is missing.

For example, in JP-A-2002-79693, a test device (dot missing testing unit) that detects a non-detection nozzle that generates the dot missing of this type has been disclosed. In this test device, when a laser beam is projected from a light emitting element toward the trajectory of ink from the nozzle and the laser beam is shielded by ink droplets ejected from the nozzle, the ink droplets are determined to be ejected normally. On the other hand, when the laser beam is not shielded, the test nozzle is detected as the non-ejection nozzle that cannot eject ink. In addition, when the non-ejection nozzle is detected, a cleaning operation is configured to be performed for the nozzle of the record head. In addition, in JP-A-2002-79693, a test device using a vibration plate testing method in which dot missing is tested by checking whether a vibration plate disposed on the surface is vibrated by the ink droplets has been disclosed.

Even when dots are missing in spots spaced apart in an entire printed image, the dot missing is not visually distinguished that much, and accordingly, the print quality is not decreased markedly. However, when a plurality of dots located (having predetermined positional relationship) in a specific small range is missing as in a case where adjacent dots are missing or the like, the dot missing is visually distinguished, and there is a problem that the print quality is decreased markedly.

In descriptions here, existence of a non-ejection nozzle that causes dot missing due to incapability of ejecting ink of a required amount is also referred to as “nozzle missing”.

### SUMMARY

An advantage of some aspects of the invention is that it provides a nozzle missing determining device for a liquid ejecting apparatus, a liquid ejecting apparatus, and a method of determining nozzle missing that can accurately determine a nozzle defect causing missing of a group of dots in accordance with a record mode.

According to an aspect of the invention, there is provided a nozzle missing determining device that determines a nozzle missing state of a liquid ejecting apparatus including an ejection unit having a plurality of nozzles that can eject liquids to a target by detecting a non-ejection nozzle that cannot eject a liquid. The nozzle missing determining device includes: a test unit that acquires test result data by performing a test for detecting a non-ejection nozzle from among test target nozzles of the ejection unit; a mode determining unit that determines a record mode at a time when the ejection unit performs a record operation by ejecting a liquid to a target; and a nozzle missing determining unit that determines whether there is nozzle missing in which all the nozzles having predetermined positional relationship that can form missing of a group of dots determined in accordance with the determined record mode are non-ejection nozzles based on the test result data for each combination of nozzles having the predetermined positional relationship.

According to the above-described nozzle missing determining device, a test for detecting a non-ejection nozzle from among test target nozzles of the ejection unit is performed by the test unit, and thus the test result data of each test target nozzle can be acquired. The record mode at a time when the ejection unit performs a record operation by ejecting a liquid to a target is determined by the mode determining unit. The nozzle missing determining unit determines whether there is nozzle missing, in which all the nozzles having the predetermined positional relationship that can form missing of a group of dots which is determined in accordance with the determined record mode are non-ejection nozzles, based on the test result data for each combination of nozzles having the predetermined positional relationship. Accordingly, a nozzle defect that can cause missing of a group of dots can be accurately determined in accordance with the record mode. For example, only when there is the nozzle missing in which a plurality of nozzles that can form missing of a group of dots in accordance with the record mode are non-ejection nozzles, a countermeasure (for example, a cleaning operation or the like) is taken without causing any problem.

### BRIEF DESCRIPTION OF THE DRAWINGS

The invention will be described with reference to the accompanying drawings, wherein like numbers reference like elements.

FIG. 1 is a schematic perspective view of a printer according to an embodiment of the invention.

FIG. 2 is a bottom view of a record head according to an embodiment of the invention.

FIG. 3 shows adjacent nozzles according to an embodiment of the invention.

FIG. 4 is a schematic diagram showing a band print mode.

FIG. 5 is a schematic diagram showing a interlaced print mode.

FIG. 6 is a block diagram showing the electrical configuration of the printer.

FIG. 7 is a schematic diagram showing a register in which test result data is stored according to an embodiment of the invention.

FIGS. 8A and 8B are schematic diagrams showing a comparing process for a reference nozzle and a same number nozzle in a different row of a same color according to an embodiment of the invention.

FIG. 9 is a diagram showing a comparing process for a reference nozzle including nozzle #1 and a comparison nozzle according to an embodiment of the invention.

FIG. 10 is a schematic diagram showing a comparing process for a reference nozzle not including SHK1 and a comparison nozzle in the same row according to an embodiment of the invention.

FIG. 11 is a schematic diagram showing a comparing process for a first reference nozzle and a comparison nozzle in the same row in a test for the second time and thereafter according to an embodiment of the invention.

FIG. 12 is a flowchart showing a maintenance process according to an embodiment of the invention.

FIG. 13 is a flowchart showing adjacent nozzle missing determining process according to an embodiment of the invention.

### DESCRIPTION OF EXEMPLARY EMBODIMENTS

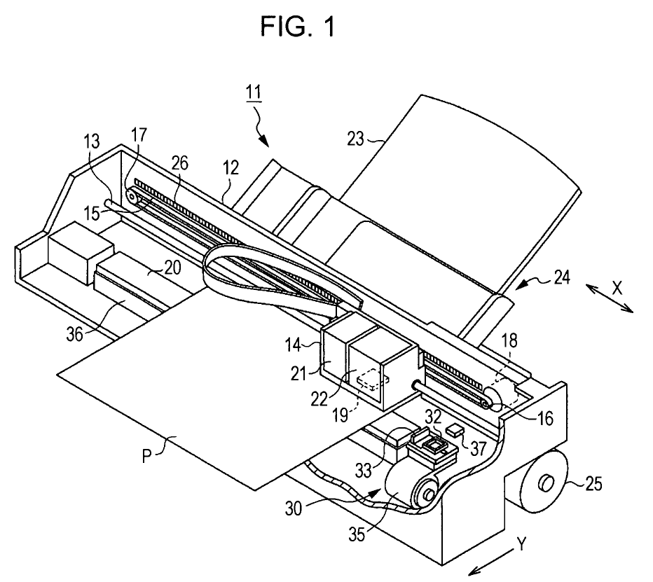

Hereinafter, an embodiment of the invention will be described with reference to FIGS. 1 to 13. FIG. 1 is a perspective view of an ink jet recording device from which an external case is detached. As shown in FIG. 1, the ink jet recording device (hereinafter, referred to as a printer 11) as a liquid ejecting device is a serial printer and includes a main body case 12 having an approximate box shape of which upper side is open. In a guide shaft 13 installed inside the main body case 12, a carriage 14 that is guided in the main scanning direction (direction X in FIG. 1) to reciprocate is disposed. A timing belt 15 having an endless shape that is fixed to the rear side of the carriage 14 is wound around one pair of pulleys 16 and 17 that are axially supported on the inner surface of the rear face part of the main case 12. By driving a carriage motor 18 having a driving shaft, which is connected to one pulley 16, forwardly or reversely, the carriage 14 is configured to reciprocate in the main scanning direction X.

Below the carriage 14, a record head 19 as a discharge unit that discharges (ejects) ink droplets is disposed. Inside the main case 12, in a lower position for facing the record head 19, a platen 20 that regulates a gap between the record head 19 and a recording sheet P as a target is disposed. In addition, on the upper part of the carriage 14, black and color ink cartridges 21 and 22 are loaded to be detachable. The record head 19 discharges ink of colors that is supplied from the ink cartridges 21 and 22 from each nozzle constituting nozzle rows of each color.

On the rear side of the printer 11, a paper feed tray 23 and an auto sheet feeder 24 that separates only the uppermost one sheet of a plurality of recording sheets P loaded on the paper feed tray 23 and feeds the sheet in the sub scanning direction Y are disposed.

In addition, in the right lower part of the main body case 12 in FIG. 1, a paper feed motor 25 is disposed. By driving the paper feed motor 25, a pair of transport rollers and a pair of discharge rollers, which are not shown in the figure, are driven to rotate, and thereby the recording sheet P is transported in the sub scanning direction Y. Then, in the middle of movement of the carriage 14 in the main scanning direction X, by alternately repeating a print operation for ejecting ink droplets toward the recording sheet P from nozzles of the record head 19 and a paper feed operation for transporting the recording sheet P by a predetermined paper feed amount in the sub scanning direction Y, a printing process is performed for the recording sheet P.

In addition, in the printer 11, a linear encoder 26 that outputs pulses of which number is in proportion to a moving distance of the carriage 14 is installed to be aligned along the guide shaft 13. By using the output pulses of the linear encoder 26, the position of the carriage 14 in the main scanning direction and the moving speed and moving direction of the carriage 14 are acquired.

As shown in FIG. 1, in the printer 11, the right-end position of the moving path of the carriage 14 is set as a home position. Right below the carriage 14 at a time when the carriage 14 is located in the home position, a maintenance device 30 that performs a cleaning process for preventing and clearing nozzle clogging of the recording head 19 or the like is disposed. The maintenance device 30 includes a cap 32, a wiper 33, and a suction pump 35. By driving the suction pump 35 in a state in which the cap 32 is brought into contact with the nozzle opening face of the record head 19 and having a space surrounded by the nozzle opening face and the cap 32 to be in a negative-pressure state, ink is forcedly sucked from the nozzles of the record head 19 for performing a cleaning process. By performing the cleaning process, ink having increased viscosity located inside the nozzles, air bubbles contained in the ink, or the like is removed for preventing and clearing the nozzle clogging or the like, and the ink sucked from the nozzles passes through the cap 32 and the suction pump 35 and is discharged into a waste liquid tank 36 that is disposed on the lower side of the platen 20.

In the printer 11 according to this embodiment, a nozzle testing device 37 that tests whether there is nozzle clogging (ejection-failed nozzle) of the record head 19 is disposed near the maintenance device 30. The nozzle testing device 37 tests clogging of each nozzle by detecting whether ink droplets are actually ejected (whether there is ejection of ink droplets) from each nozzle in a case where the record head 19 is driven to be able to sequentially eject test ink droplets from the nozzles. As the test method, various methods may be used as long as the methods can test the nozzle clogging. For example, there is a laser method in which a relative position between a light emitting device and the record head 19 is adjusted such that a laser beam, for example, emitted from the light emitting device and the trajectory of ink (predicted path) of test nozzles intersect each other, and a test nozzle is determined as a non-ejection nozzle in a case where shield of the laser beam by ink droplets ejected from the nozzle cannot be detected by a light receiving device. The laser method, for example, may use a test device disclosed in JP-A-2002-79693. In addition, a test device disclosed in JP-A-2002-79693 that uses a vibration plate testing method, in which dot missing is tested by checking whether a vibration plate disposed on the surface is vibrated by ink droplets, may be used. In addition, as another method, an electric-field detecting method may be used. In other words, a voltage is applied between the record head 19 and the cap 32 to be charged positively and negatively, and in a process in which ink droplets that are negatively charged and ejected from the record head 19 approach the cap 32 that is positively charged, the electric field between the record head 19 and the cap 32 changes due to electrostatic induction. In addition, when the ink droplets land in the cap 32, the charges are neutralized to change the electric field. Then, a measured signal (for example, a cap electric-potential signal), on which the change in the electric field is reflected, is integrated by an integrating circuit. When the integrated value does not exceed a predetermined threshold value, the test nozzle is determined as a non-ejection nozzle. In addition, the non-ejection nozzle does not necessarily indicates a nozzle that cannot eject an ink droplet at all and includes a nozzle that can eject only ink droplets not reaching the amount of ink required for forming a dot of a required size. This is determined based on the detection sensitivity of the nozzle testing device 37, setting of an abnormality determining threshold value, or the like.

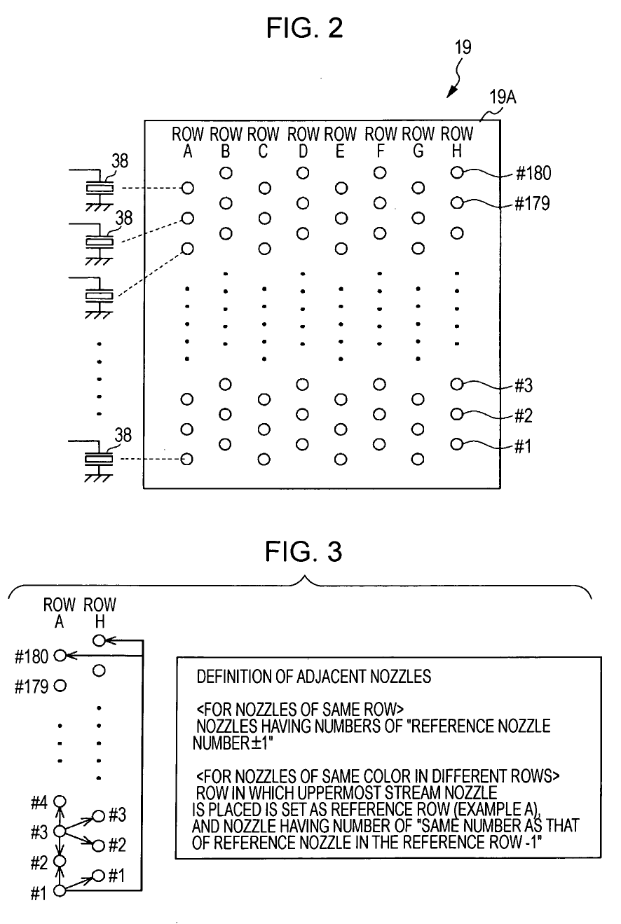

FIG. 2 shows a bottom face (nozzle opening face) of the record head. A shown in FIG. 2, the bottom face of the record head 19 is formed as the nozzle opening face 19A on which a plurality of nozzles are opened. On the nozzle opening face 19A, total eight nozzle rows of rows A to H each constituted by a total of 180 nozzles #1 to #180 that are arranged in one line with a predetermined nozzle pitch in the sub scanning direction (vertical direction in FIG. 2) are formed. From the left side, the nozzle rows of even rows (rows B, D, F, and H) are shifted from the nozzle rows of odd rows (rows A, C, E, and G) by a half of the nozzle pitch to the downstream side (the upper side in FIG. 2) in the direction of transport of the paper sheet, and the nozzles are disposed in a zigzag pattern by the nozzle rows of the odd nozzle rows and the even nozzle rows. In this example, to the nozzles constituting each nozzle row, reference signs “#1 to #180” are sequentially attached from the upstream side in the direction of transport of the paper sheet. In this example, the total eight nozzle rows are used for performing a printing process of four-colors including black (K), cyan (C), magenta (M), and yellow (Y). Combinations of two nozzle rows having a same ink color are (row A, row H), (row B, row G), (row C, row F), and (row D, and row E).

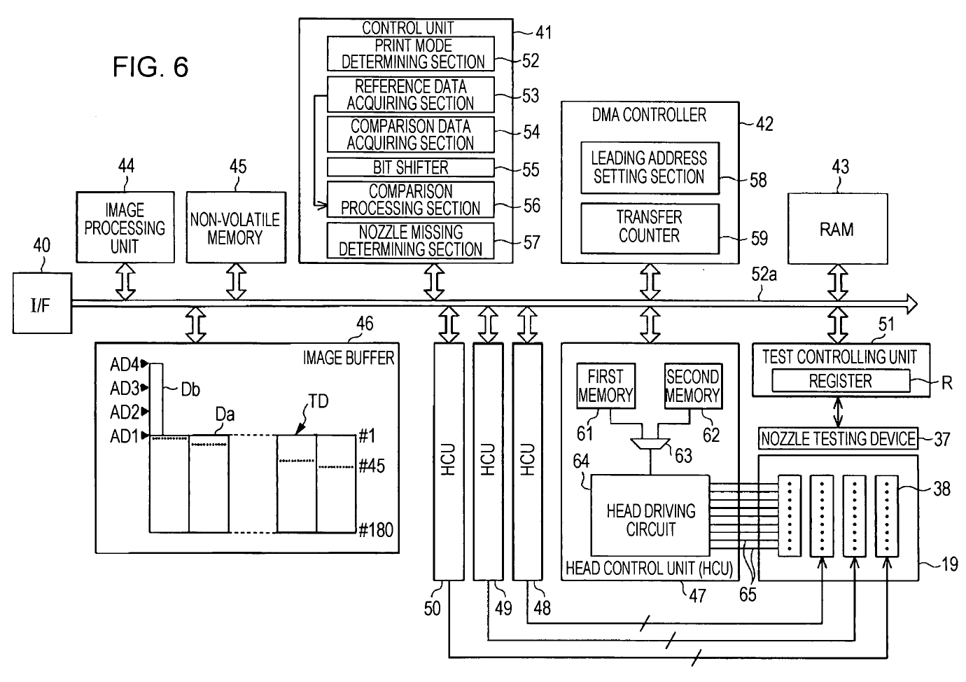

In addition, in the record head 19, ejection elements 38 shown in FIG. 2, which are in correspondence with the nozzles #1 to #180, corresponding to the number of the nozzles are built in (however, in FIG. 2, the ejection elements 38 are schematically shown on the outer side of the record head 19). The ejection element 38, for example, is formed of a piezoelectric vibrator or an electrostatic driving element. When a voltage pulse having a predetermined driving waveform is applied to the ejection element 38, an inner wall part (vibration plate) of an ink chamber that is communicated with the nozzle is vibrated by an electrostriction operation or an electrostatic driving operation, and by expanding or compressing the ink chamber, ink droplets are ejected from the nozzle. In addition, the ejection element 38 may be a heater that heats the ink placed inside a nozzle passage, and a method in which ink droplets are ejected from the nozzle by using expansion of air bubbles generated inside the ink heated by the heater at a time when the film is boiled may be used. In addition, control of the voltage of the ejection element 38 is performed by head control units 47 to 50 (shown in FIG. 6).

The printer 11 receives print data from a host device (not shown) and performs a printing process for a record sheet P in a record mode corresponding to a printing method that is designated by information included in the header of the print data. As the record mode, for example, there are a band printing method (band print mode) that is used in a high-speed print mode and an interlaced printing method (interlaced print mode) that is used in a high-quality print mode. In this embodiment, the band print mode corresponds to a first mode, and the interlaced print mode corresponds to a second mode.

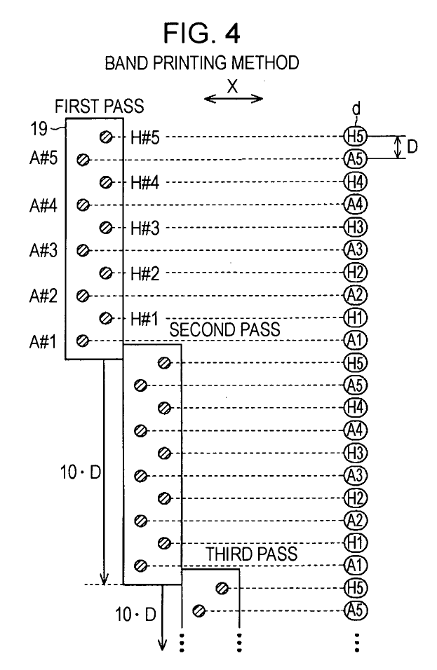

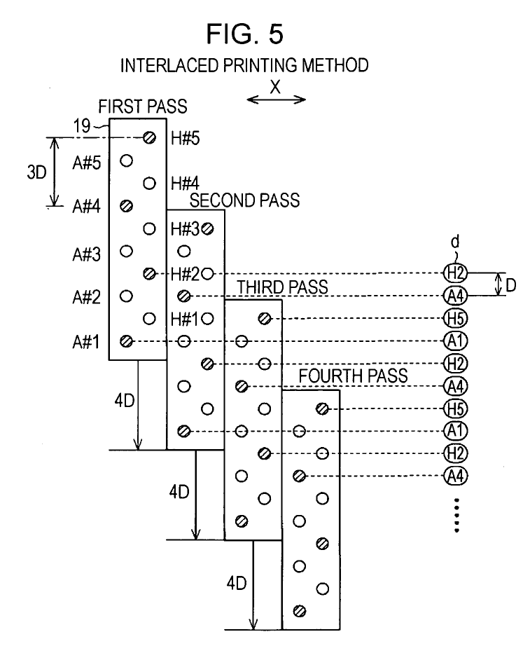

FIG. 4 is an explanatory diagram showing a band printing process, and FIG. 5 is an explanatory diagram showing the interlaced printing process. In these figures, for the convenience of description, only nozzle rows of the record head 19 corresponding to one color (two nozzle rows) for a case where the number of nozzles for each one row is five are shown. In addition, in the figures, the horizontal direction in the figures is set as the moving direction (main scanning direction X) of the carriage 14. In the figures, nozzles that are used for ejecting ink droplets are hatched. In addition, in the figures, a relative position of the record head 19 with respect to the recording sheet P that is transported in the paper feed direction is represented.

First, the band printing method (band print mode) will be described. As shown in FIG. 4, the band printing method is a printing method that is performed by using all the nozzles #1 to #180. In the record head 19 shown in FIG. 4, as two nozzle rows corresponding to a predetermined ink color, only two rows of rows A and H for which the total number of the nozzles is five are drawn.

As shown in FIG. 4, in the band printing method, for example, the total nozzles A#1 to A#5 and H#1 to H#5 are used as use nozzles for ink ejection in the process in which the record head 19 moves in the main scanning direction X. Accordingly, dots d are printed with a dot pitch (that is, a nozzle pitch) D in the sub scanning direction (the vertical direction in the figure). In FIG. 4, a reference sign written into each dot d denotes the nozzle row to which the nozzle that ejects ink droplets for forming the dot belongs and a nozzle number. For example, a reference sign “H5” denotes a dot d that is formed by ink droplets ejected from a nozzle #5 of the nozzle row H. In the band printing method, the printing process for the entire nozzles (10 nozzles) is performed in one scanning operation, and thus, the paper feed pitch is “10·D” that is a feed pitch corresponding to “the entire nozzle gaps 9·D+one nozzle pitch D”. In addition, in the band printing method, two nozzles corresponding to adjacent dots become a combination of adjacent nozzles. Accordingly, the affect of the deviation due to the processing precision of the nozzle may be easily the deviation of gaps of the dots, and thus, banding (a white line or the like) can be generated in a relatively easy manner.

Next, the interlaced printing method (interlaced print mode) shown in FIG. 5 is a recording method in which the banding, which is a problem of the band printing method, can be easily avoided. In the interlaced printing method, a printing process is performed by using some nozzles of the total nozzles in the nozzle rows that have a gap corresponding to a predetermined number of nozzles therebetween. In the example of FIG. 5, the use nozzles of the total nozzles in two nozzle rows of a same color are determined such that the use nozzles are spaced apart by a gap of “3·D” from each other in the sub scanning direction (the vertical direction in FIG. 5). In other words, in the example of FIG. 5, nozzles A#1, H#2, A#4, and H#5 are determined as the use nozzles that are used for the printing process.

When ink droplets are ejected from the use nozzles in the process (for example, a first pass) of moving the record head 19 in the main scanning direction X, dots are formed with a gap of 3·D (corresponding to two dots) therebetween in the sub scanning direction. The next pass (for example, a second pass) is performed after the paper sheet is transported by 4·D, and when ink droplets are ejected from nozzles A#1, H#2, A#4, and H#5 in the process of moving the record head 19 in the main scanning direction X, dots are formed so as to fill in the gaps between the dots printed in the previous pass. Accordingly, by ejecting ink droplets from use nozzles that are spaced apart from each other by a gap of “3-d” in the process of moving the record head 19 in the main scanning direction X each time the paper sheet is transported by 4·D, two nozzles corresponding to adjacent dots d are not adjacently located. Accordingly, in the interlaced printing process, it is easy to prevent banding caused by the deviation of processing precision of the nozzles.

When dot missing is scattered with a predetermined distance (for example, several tens of dots) or more therebetween in a printed image, the dot missing is not visually distinguished. However, when there is a plurality of dot missing (hereinafter, referred to as “dot group missing”) within a very small range (local range) in the printed image, the dot group missing is visually distinguished in the printed image. Accordingly, in this embodiment, when all the nozzles having a predetermined positional relationship that can form this type of dot group missing are determined to be in a nozzle-missing state based on the test result of the nozzle testing device 37, a cleaning process is configured to be performed by using the maintenance device 30.

In this embodiment, as one target type of the dot group missing, “continuous two dots missing” in which adjacent two dots d (continuous two dots) are missing together is used. In addition, “one-skip two dots missing” in which two dots are missing together with one dot interposed therebetween (one-skip two dots) is visually distinguished in a printed image, and thus, it is used as a target type of the dot group missing. Thus, in this embodiment, the predetermined positional relationship of nozzles represents the positional relationship of two nozzles (hereinafter, also referred to as near nozzles) corresponding to adjacent two dots (continuous two dots) and the positional relationship of two nozzles (hereinafter, also referred to as distant nozzles) corresponding to “one-skip two dots”. Here, each positional relationship of two nozzles (near nozzles) corresponding to adjacent dots or two nozzles (distant nozzles) corresponding to “one-skip two dots” is different for the band printing method shown in FIG. 4, and the interlaced printing method shown in FIG. 5. In addition, in descriptions here, the “near nozzles” and “distant nozzles” described above are collectively referred to as “adjacent nozzles”.

FIG. 3 is an explanatory diagram showing adjacent nozzles in a band printing process.

Of nozzle rows in two rows (rows A and H) having a same color, a row in which the uppermost stream nozzle is located is set as a reference row (in the example shown in FIG. 3, a row A on the side on which a nozzle #1 located in the uppermost stream (the lowest end) is located). One nozzle in the reference row is set as a reference nozzle, and a nozzle having the positional relationship of the adjacent nozzles for the reference nozzle is set as a comparison nozzle. The adjacent nozzles are defined by determining the reference nozzle and the comparison nozzle by using the following rule. Here, when the comparison nozzle for the reference nozzle is determined, in this example in which there are nozzle rows in two rows having a same color, as a comparison target row from which the comparison nozzle is determined, there are a same row and a same-color in a different row for the reference row.

For nozzles located in the same row, nozzles having numbers that are the number of the reference nozzle “±1” become the comparison nozzles that satisfy the positional relationship of the adjacent nozzles (in particular, the distant nozzles). For example, when nozzle #3 of the reference row (row A) shown in FIG. 3 is set as the reference nozzle, nozzles #2 and #4 located in the same row (row A) become the comparison nozzles. In addition, in a band printing process in which the record head 19 is transported with respect to the paper sheet by a distance (in the example shown in FIG. 4, 10·D) of the total number of nozzles×D each time, nozzles #1 and #180 are in the positional relationship satisfying the distant nozzles. Thus, in the band printing process, the reference nozzle is numbered in the order for circulating from #1 to #180, “−1” of #1 becomes “#180”, and “+1” of #180 becomes “#1”. Accordingly, when the nozzle #1 or #180 that is located in the end part of the reference row is set as the reference nozzle, for example, when nozzle #1 located in the reference row (row A) is set as the reference nozzle, nozzles #2 and #180 in the same row (row A) become the comparison nozzles (see FIG. 3). In addition, when nozzle #180 located in the reference row (row A) is set as the reference nozzle, nozzles #1 and #179 located in the same row (row A) become the comparison nozzles.

In addition, for a nozzle in a different row of a same color, a nozzle having a same number as that of the reference nozzle located in the reference row and a nozzle having the number of “the number of the reference nozzle−1” become comparison nozzles that satisfy the positional relationship of the adjacent nozzles (in particular, the near nozzles). For example, as shown in FIG. 3, when nozzle #3 located in the reference row (row A) is set as the reference nozzle, in a different row (row H) having the same color, nozzle #3 having the same number as that of the reference nozzle and nozzle #2 having the number of “the number of the reference nozzle−1” become the comparison nozzles. In addition, when a nozzle located in the end part of the reference row (row A) is the reference nozzle, for example, when nozzle #1 located in the reference row (row A) is set as the reference nozzle, in a different row (row H) of the same color, nozzle #1 having the same number as that of the reference nozzle and nozzle #180 having the number of “the number of the reference nozzle−1” become the comparison nozzles.

As described above, in the band printing process, in the same row (row A) as the reference row (row A), nozzle A#(n−1) and A#(n+1) having numbers of “the number of the reference nozzle A#n±1” become the comparison nozzles. In addition, in a different row (row H) having the same color, nozzle H#n having a same number as the number of the reference nozzle and a nozzle H#(n−1) having the number of “the number of the reference nozzle−1” become the comparison nozzles.

On the other hand, in the interlaced printing process, as can be known from FIG. 5, when one nozzle of the use nozzles (#1 and #4) located in the reference nozzle (row A) is set as the reference nozzle #k, the use nozzles (#4 and #1) of nozzles having numbers of “k±(n/2+1)” acquired from “the number of the reference nozzle±3” (in the case of a feed pitch of n·D, ±(n/2+1)) in the same row (row A) are comparison nozzles that satisfy the positional relationship of the adjacent nozzles with respect to the reference nozzle (in particular, distant nozzles). In addition, in the different row (row H) of a same color, the use nozzles (#2 and #5) having numbers of “the number of the reference nozzle #k+1” and “the number of the reference nozzle #k+2” and the use nozzles (#5 and #2) having numbers of “the number of the reference nozzle #k+3” and “the number of the reference nozzle #k+4” become the comparison nozzles. In other words, in the different row of a same color, nozzles having numbers that are identical to the numbers of the use nozzles having numbers of “k+n/2−1” and “k+n/2” acquired from “the number “k” of the reference nozzle #k+n/2−1” and “the number “k” of the reference nozzle #k+n/2” become the comparison nozzles in the case of the feed pitch of n·D. When there are 180 nozzles, the basic way of thinking is the same. In addition, the relationship of the number of the comparison nozzle and the number of the reference nozzle is represented by one rule having regularity which is determined for each interlaced recording method that is defined from the pitch of the use nozzles used for the interlaced printing method or the feed pitch n·D of the record head 19, and is not limited to the above-described expression used for determining the number.

FIG. 6 is a block diagram showing the electrical configuration of the printer 11. The printer 11 includes a communication interface 40, a control unit 41, a DMA controller 42, a RAM 43, an image processing unit 44, a non-volatile memory 45, an image buffer 46, head control units 47 to 50 (HCU), and a test control unit 51. These constituent members are interconnected though a bus 52a.

The control unit 41 is responsible for print control of the printer 11, directs to generate and transfer test ejection data that is needed for the test control unit 51 to control the nozzle testing device 37 that tests the nozzles of the record head 19, and performs a dot-missing determining process based on the test result data that is acquired by testing the nozzles of the record head 19 by using the nozzle testing device 37. This result of the dot-missing determining process is used as a cleaning condition for the maintenance device 30.

The control unit 41 includes a print mode determining section 52 used for determining the print mode, a reference data acquiring section 53 used for performing the dot-missing determining process, a comparison data acquiring section 54, a bit shifter 55, a comparison processing section 56, and a nozzle-missing determining section 57.

The printer 11 receives print data, for example, from a host device (not shown) through the communication interface 40. The print data is transmitted in units of data corresponding to one pass (one scanning operation of the record head). After, the received print data is temporarily stored in a reception buffer (not shown), print image data (bit map data) of the print data is sequentially expanded on the image buffer 46 by the image processing unit 44, and each data (line data) corresponding to one scanning operation of the record head 19 is transmitted to the head control units 47 to 50. In addition, the control unit 41 interprets a command included in the print data and controls driving of the carriage motor 18 and the paper feed motor 25 (see FIG. 1) based on the command. Accordingly, a printing operation for ejecting ink droplets from nozzles of the record head 19 with the carriage 14 moved in the main scanning direction X and a paper feed operation for feeding a record sheet P by a designated pitch are alternately performed.

In addition, the control unit 41, in the nozzle testing process, controls the image processing unit 44 to generate test ejection data TD by using the original data of the test ejection data that is stored in the non-volatile memory 45 and expands the test ejection data TD in the image buffer 46.

The test ejection data TD includes unit ejection data Da in which one test block is in correspondence with “45 nozzles” that correspond to ¼ of the total number of nozzles (180 nozzles) and blank data Db (non-ejection data) formed of null data that is continuously added to the front side of the unit ejection data Da in the direction for reading and has a data length corresponding to “135 nozzles”. The unit ejection data Da is data that is used for directing ejection of ink droplets corresponding to “45 nozzles” in the order of test ejection. In a test process, the test ejection data TD that can be used for testing each ¼ (45 nozzles) of the total nozzles (180 nozzles) is transferred to the head control units 47 to 50 a plurality of times (in this embodiment, four times) while each leading address (transfer start address) is changed by a length corresponding to “145 nozzles” within the range of the blank data Db to the upstream side in the direction for reading in the order of AD1, AD2, AD3, and AD4.

The DMA controller 42 shown in FIG. 2 performs direct transfer (DMA transfer) for the image data (the print image data or the test ejection data TD) that is expanded in the image buffer 46 in accordance with a transfer direction from the control unit 41 to the head control units 47 to 50. The DMA controller 42 includes a leading address setting section 58 that can set the leading address, which is a transfer start position in the image buffer 46, and a transfer counter 59 (for example, a countdown counter) that measures the length of data in the transfer process until transfer of data corresponding to a length set by the control unit 41 is completed. When it is a nozzle test period set in advance, the control unit 41 writes and sets the leading address AD1 into the leading address setting section 58, sets a one-time transfer data length for the test ejection data in the transfer counter 59, and then, directs the DMA controller 42 to transfer the test ejection data TD from the image buffer 46 to the head control units 47 to 50.

The DMA controller 42 starts transfer of the test ejection data TD from the leading address AD1 stored in the image buffer 46 which is set in the leading address setting section 58 based on the transfer direction from the control unit 41. Then, when the value of the total transfer data length that is set in the transfer counter 59 by the control unit 41, for example, is counted down to reach a value (for example, “0”) for completing the data transfer, the DMA controller 42 completes the transfer of the test ejection data TD for the first time. When transfer of the test ejection data TD for the first time is completed, the control unit 41 sets a leading address AD2 shifted by bits corresponding to “45 nozzles” in the leading address setting section 58 and performs the transfer process for the test ejection data TD for the test ejection data for the second time in the same manner. Thereafter, the control unit 41 performs the same transfer process with the leading address changed to AD3 and AD4, and thus, transfer of a total of four times is repeated. Each predetermined bytes of the test ejection data TD is alternately stored in a first memory 61 and a second memory 62 that are installed inside the head control units 47 to 50. Then, a head driving circuit 64 controls driving of the record head 19 based on the ejection data read from selected one between the memories 61 and 62 that are alternately selected by a data selection unit 63.

Here, four head control units 47 to 50 for ink colors (nozzle rows) are disposed. Each head control unit 48 to 50 has a same internal configuration as that of the head control unit 47 shown in FIG. 6. In addition, a head driving circuit 64 disposed inside each head control unit is electrically connected to the ejection elements 38 (see FIG. 3) disposed inside the record head 19 through signal lines 65 corresponding to the number of the nozzles. The ejection data is data in which one dot is represented by one bit. As the head driving circuit 64 controls voltages applied to the ejection elements 38 corresponding the nozzles based on the ejection data, ink droplets are not ejected from nozzles corresponding to a dot value of “0” of the ejection data, and ink droplets are ejected from nozzles corresponding to a dot value of “1”. For example, in a nozzle test process, as the head control unit 47 controls driving of the ejection elements 38 based on the test ejection data TD that is received from the image buffer 46 by the head control unit 47, ink droplets are ejected from each nozzle in a predetermined test order (that is, the order of ejection).

In addition, the test control unit 51 is electrically connected to the nozzle testing device 37. When it is a predetermined test period in accordance with the direction of the control unit 41, the test control unit 51 performs a nozzle testing process in which whether there is a non-ejection nozzle is tested for all the nozzles of the record head 19 by controlling the nozzle testing device 37. The nozzle testing device 37, as described above, uses a laser method or an electric-field detecting method. As shown in FIG. 6, inside the test control unit 51, a register R is included. The detection result data of the nozzle testing device 37 is output to the test control unit 51, and the detection result data is stored in the register R disposed inside the test control unit 51. In addition, in this embodiment, the control unit 41 and the test control unit 51 are configured by at least one of a CPU and an ASIC (Application Specific IC). In addition, the control unit 41 and the test control unit 51 may be configured as software by using a CPU that executes a program, or may be configured as hardware such as an integrated circuit. Alternatively, the control unit 41 may be configured as a combination of software and hardware.

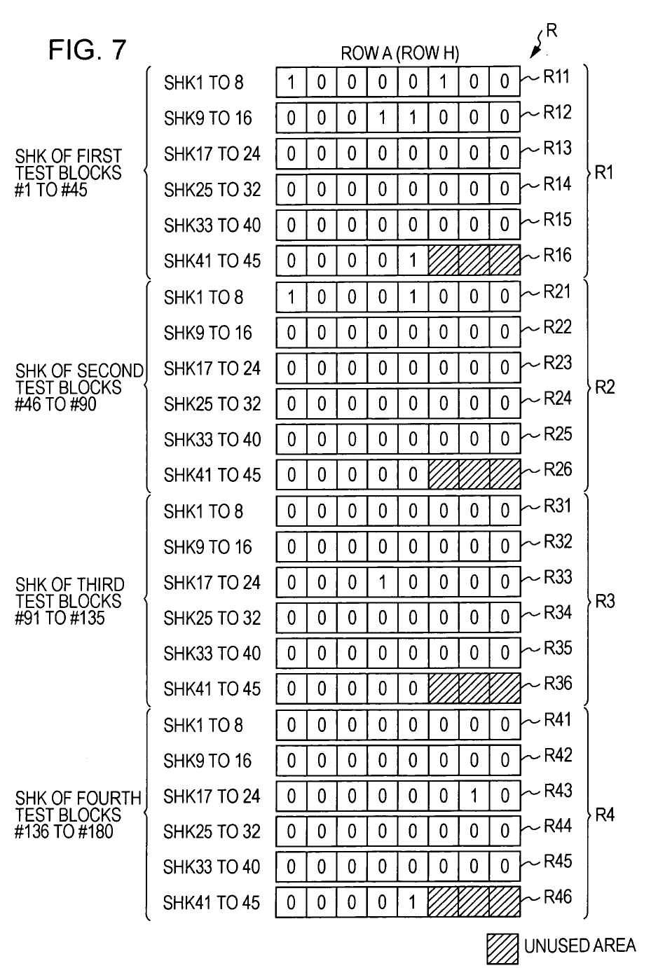

FIG. 7 shows the configuration of the register. The register R includes a plurality of (in this example, four) register groups R1 to R4. The test process performed by the nozzle testing device 37 is performed by dividing the total 180 nozzles into 4 test blocks and repeating a test for each test block corresponding to 45 nozzles four times. The test result data for test blocks is sequentially stored in the register groups R1 to R4. In each register group R1 to R4, six registers R11 to R16, R21 to R26, R31 to R36, and R41 to R46 each having a storage area of one byte are configured in parallel to one another. In one register group, test result data in units of one test block corresponding to 45 nozzles are stored in storage areas of 8 bit×6 row=48 bits from the leading address. In other words, test result data of nozzles #1 to #45 is stored in a first register group R1, test result data of nozzles #46 to #90 is stored in a second register group R2, test result data of nozzles #91 to #135 is stored in a third register group R3, and test result data of nozzles #136 to #180 is stored in a fourth register group R4.

Accordingly, the register R has one register group including four registers R1 to R4 and has a total of 24 (=number of test blocks “4”×number of registers for each test block “6”) registers R11 to R46 for storing the test result data. Here, among the reference signs of the registers, for example, “R12” denotes a register positioned in the second row of the first test block (that is, the first register group).

As shown in FIG. 7, since a test process is performed for 45 nozzles in the first test block, among six registers for each block, as shown in FIG. 7, the test result data SHK1 to SHK8 corresponding to nozzles #1 to #8 is stored in a register R11 positioned in the first row, the test result data SHK9 to SHK16 corresponding to nozzles #9 to #16 is stored in a register R12 positioned in the second row. In addition, similarly, the test result data SHK17 to SHK24, SHK25 to SHK32, and SHK33 to SHK40 are stored in registers R13 to R15 positioned in the third to fifth rows. In addition, in a register R16 positioned in the final row, the test result data SHK41 to SHK45 corresponding to nozzles #41 to #45 is stored. In other words, in a register R1n positioned in the n-th row (here, n=1 to 5), the test result data SHK(8n−7) to SHK(8n) corresponding to nozzles #(8n−7) to #8n is stored, and all the 8 bits are used. However, in the register R16 positioned in the final 6th row, only test result data SHK 41 to SHK45 for five tests corresponding to nozzles #41 to #45 is stored, and thus, the last 3 bits form an unused area.

As above, a method of storing data for one test block has been described. For the other three test blocks, 45 values of one-bit test result data corresponding to the number of test nozzles are stored in each six (6 bytes) registers R21 to R26, R31 to R36, and R41 to R46. In addition, only 5 values of the test result data SHK41 to SHK45 are stored in each last register R26, R36, and R46 of each test block, and the last 3 bits thereof form an unused area. Here, the test result data is data of one bit for each one nozzle. For example, when there is no nozzle missing, the test result data become “0”. On the other hand, when there is nozzle missing, the test result data becomes “1”. FIG. 7 shows an example of the test result data. For example, in the figure, a nozzle corresponding to the test result data value of “1” represents a non-ejection nozzle (dot missing nozzle).

Next, the print mode determining section 52, the reference data acquiring section 53, the comparison data acquiring section 54, the bit shifter 55, the comparison processing section 56, and the nozzle-missing determining section 57 that are used by the control unit 41 for performing an adjacent nozzle missing determining process will be described one after another.

The print mode determining section 52 acquires the print mode based on print condition information included in the header of the print data that is received, for example, from a host device. In this example, the print mode determining section 52 acquires whether the print mode is the band print mode (first mode) or the interlaced print mode (second mode). Then, the content of the adjacent nozzle missing determining process that is performed by using the test result data stored in the register is determined based on the print mode.

The reference data acquiring section 53, the comparison data acquiring section 54, the bit shifter 55, the comparison processing section 56, and the nozzle-missing determining section 57 perform the adjacent nozzle missing determining process based on the content of the print mode.

The reference data acquiring section 53 is used for acquiring detection result data of the reference nozzle. Before the nozzle-missing determining process is performed, the control unit 41 temporarily writes the detection result data stored in the register R into the RAM 43 and then, performs the nozzle-missing determining process by using the detection result data of the RAM 43. As described above, in the nozzle-missing determining process, a process for comparing data of the reference nozzle and the comparison nozzle is performed for each one byte (eight nozzles), and the reference data acquiring section 53 reads one byte data (detection data) of the reference nozzle that is a current comparison target from a predetermined area in the RAM 43. The addresses of the detection result data of each nozzle in the RAM 43 are acquired by the control unit 41, and the reference data acquiring section 53 reads byte data from the address corresponding to the current reference nozzle.

The comparison data acquiring section 54 reads the detection result data corresponding to the current comparison nozzle in the nozzle-missing determining process from a predetermined storage area of the RAM 43. However, acquisition of data is performed in units of one byte. Thus, when the detection result data of the comparison nozzle exists over different bytes, data of all (two) the bytes including the detection result data of the comparison nozzle is acquired.

When the comparison data acquiring section 54 acquires data of a plurality of bytes, the bit shifter 55 is used for generating the byte data of the comparison nozzle from the data of the bytes. The bit shifter 55 performs a bit shifting process in which data of the plurality of bytes is individually bit-shifted for having the bit position of the byte data of the reference nozzle and the bit position of the comparison nozzle to be compared thereto to be in correspondence with each other and a data generating process in which bit values (detection result data) corresponding to the comparison nozzle are stored in one byte data with the bit positions of each byte data after the bit shift are maintained.

The comparison processing section 56 performs a comparing process in which the byte data of the reference nozzle and the byte data of the comparison nozzle are compared with each other and generates result data of determination of adjacent nozzle missing. In particular, this comparing process is performed by using a logical multiplication operation (AND operation) of the byte data of the reference nozzle and the byte data of the comparison nozzle. For example, when a set of nozzles #n and #m corresponding to adjacent dots are comparison targets, and the bit values of each detection result are “1”s (nozzle missing), the result of logical AND operation thereof becomes “1”. In other words, when the result data of determination includes a bit value of “1”, it is determined that there is adjacent nozzle missing.

The nozzle-missing determining section 57 determines whether there is the adjacent nozzle missing based on the result data of determination on the adjacent nozzle missing. In particular, when a bit value of “1” is included in the result data of the determination, it is determined that there is the adjacent nozzle missing.

When the determination result indicating that there is the adjacent nozzle missing is acquired, the control unit 41 performs a cleaning process for the record head 19 by driving the cap 32 of the maintenance device 30 and the suction pump 35 through a driving circuit not shown in the figure. In other words, the cap 32 is brought into contact with the nozzle opening face 19A of the record head 19 that is located in the home position to be capped, and under the capped state, the suction pump 35 is driven. At this moment, the control unit 41 has acquired the number of nozzle missing detections in advance by counting the number of values of “1” in the test result data of the total nozzles which is stored in the register R in advance and drives the suction pump 35 at a rotation speed corresponding to the cleaning strength determined based on the number of the nozzle missing detections. Accordingly, in this example, performing or not-performing the cleaning operation is determined based on whether there is the adjacent nozzle missing, and the strength of the cleaning operation is determined based on the total number of the nozzle missing detections. As the number of nozzle missing detections increases and the cleaning strength increases, the suction pump 35 is driven at a higher speed, and ink is sucked and discharged forcedly from the nozzle opening due to negative pressure applied to the inside of the cap 32.

Hereinafter, the nozzle test and the adjacent nozzle missing determining process will be described. When it is a predetermined nozzle test period, that is, for example, when the printer 11 is started to operate, the printer 11 is in a standby state at a time when a predetermined time elapses after the previous cleaning operation, or a user performs manipulation for directing the nozzle test, the control unit 41 performs a nozzle testing operation. First, the control unit 41 directs the image processing unit 44 to generate the test ejection data. The image processing unit 44 reads the original data from the non-volatile memory 45 in accordance with the direction and expands the test ejection data TD shown in FIG. 6 in the image buffer 46 based on the original data. The control unit 41 directs the DMA controller 42 to transmit the test ejection data TD four times while sequentially setting the leading addresses AD1 to AD4 in the leading address setting section 58. By performing the transmission four times, a test for the total nozzles (8 rows×180 nozzles) of the record head 19 is performed four times, each for 45 nozzles for one row. In other words, a test for nozzles #1 to #45 is performed in the first test block, a test for nozzles #46 to #90 is performed in the second test block, a test for nozzles #91 to #135 is performed in the third test block, and a test for nozzles #136 to #180 is performed in the fourth test block. In each test block, ink droplets are sequentially ejected from 45 test nozzles, and the test control unit 51 operates the nozzle testing device 37 in synchronization with ejection of the ink droplets. As the nozzle testing device 37 detects whether there is ejection of ink droplets from test nozzles, it is tested whether there is any non-ejection nozzle (nozzle missing). Each part of the test result data, which is acquired as described above, corresponding to 45 nozzles is stored in a storage area of 48 bits (6 rows×8 bits) for each one test block of the register R disposed inside the test control unit 51 shown in FIG. 6, as shown in FIG. 7. The test result data is represented by “0” for a normal nozzle and represented by “1” for a non-ejection nozzle.

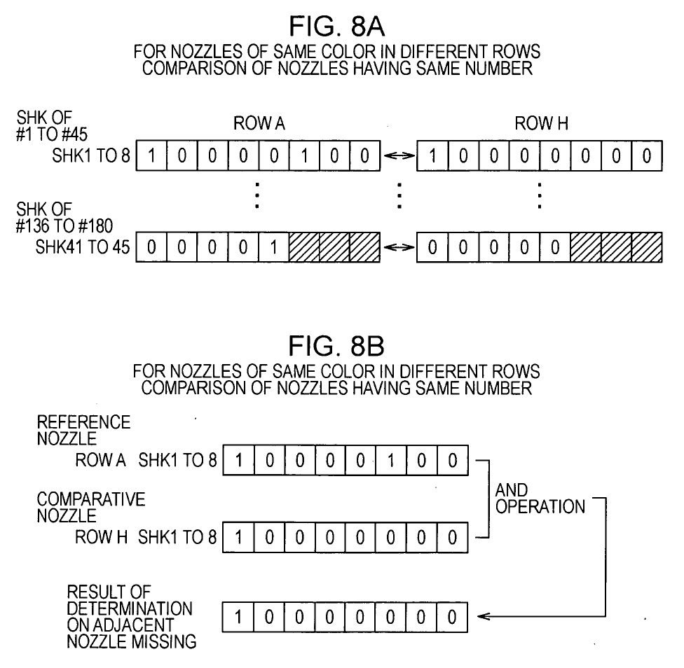

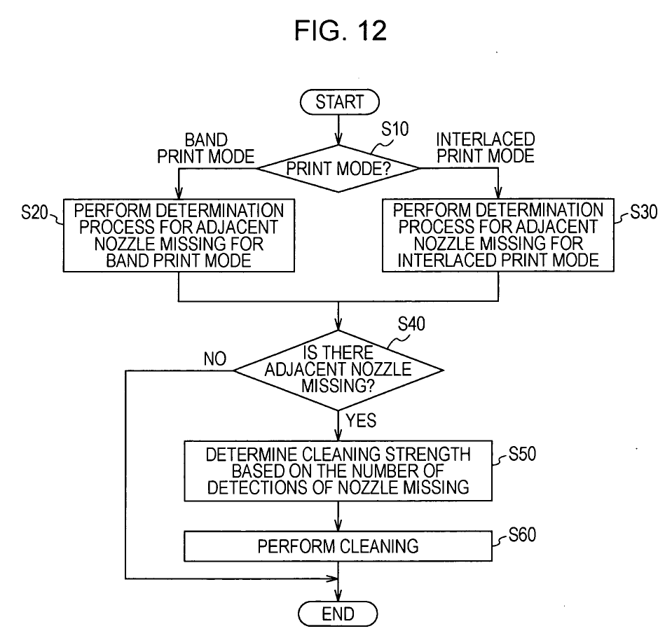

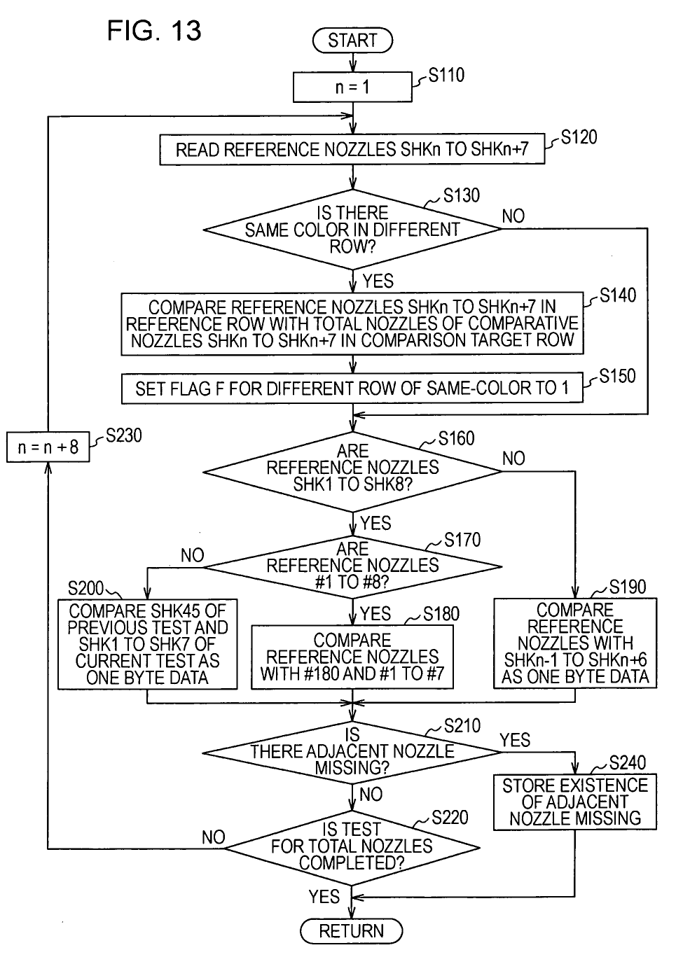

Next, the adjacent nozzle missing determining process performed by the control unit 41 by using the test result data stored in the register R will be described with reference to FIGS. 8A to 11, in accordance with a flowchart shown in FIGS. 12 and 13. The control unit 41 reads the test result data stored in the register R into the RAM 43 and performs the adjacent nozzle missing determining process with a predetermined area of the RAM 43 used as a work area. In addition, FIGS. 8A to 11 show a comparison nozzle data generating process and a comparing process in the adjacent nozzle missing determining process.

For example, when a user manipulates an input device so as to direct the host device to perform a printing process, print data is transmitted from the host device to the printer 11. When the printer 11 receives print data after a nozzle testing operation is performed at a predetermined nozzle testing period such an elapse of a predetermined time after the previous cleaning operation, the control unit 41 performs a nozzle maintenance process shown in FIG. 12. The control unit 41, first, determines the print mode (Step S10). In other words, the print mode determining section 52 of the control unit 41 acquires the print mode based on the print condition information included in the header of the print data received through the communication interface 40. In this example, as the print mode, there are a band print mode and an interlaced print mode. The print mode may be acquired as a high-speed print mode, a high-image quality print mode, and the like. In such a case, for example, when the print mode is the high-speed print mode, the record mode is acquired to be the band print mode. On the other hand, when the print mode is the high-image quality print mode, the record mode is acquired to be the interlaced print mode. When the print mode is the band print mode, an adjacent nozzle missing determining process for the band printing is performed (Step S20). On the other hand, when the print mode is the interlaced print mode, an adjacent nozzle missing determining process for interlaced printing is performed (Step S30).

When the result of the adjacent nozzle missing determining process is that there is the adjacent nozzle missing (Step S40), the cleaning strength corresponding to the number of nozzle missing detections is determined (Step S50). Then, the cleaning operation for the nozzles of the record head 19 is performed with the determined cleaning strength (S60). Here, the number of nozzle missing detections indicates the total number of non-ejection nozzles including the adjacent nozzles, and this total number is counted by the control unit 41 by using a counter (not shown) as a part of the process of Step S50. In addition, the cleaning strength is determined by adjusting the rotation speed and the driving time of the suction pump 35. As the cleaning strength increases, the suction pump 35 is controlled to have a higher rotation speed and a longer driving time.

Next, the adjacent nozzle missing determining process that is performed in Steps S20 and S30 in the above-described nozzle maintenance process will be described in detail. The adjacent nozzle missing determining process is performed by the control unit 41 using the reference data acquiring section 53, the comparison data acquiring section 54, the bit shifter 55, the comparison processing section 56, and the nozzle missing determining section 57 that are disposed inside the control unit 41. The adjacent nozzle missing determining process shown in FIG. 12 is performed for each test block. By performing the adjacent nozzle missing determining process in correspondence with the test blocks a total of four times, determination for the total nozzles (8 rows×180 nozzles) is completed. Here, the adjacent nozzle missing determining process for band printing of Step S20 will be described as an example with reference to FIG. 12. In descriptions for FIG. 12 below, the test result data of nozzle #m may be described as “nozzle SHKm”.

As shown in FIG. 12, at the start of the adjacent nozzle missing determining process, first, it is set that n=1 (Step S110). Next, the reference data acquiring section 53 reads in the reference nozzles SHKn to SHKn+7 (Step S120). Then, it is determined whether there is a different row of a same color (Step S130). Here, since the record head 19 according to this embodiment is a record head in which a different row of a same color for the reference row is included, the process proceeds to Step S140.

In Step S140, a process for comparing reference nozzles SHKn to SHKn+7 of the reference row (for example, row A in FIGS. 2 and 3) with comparison nozzles SHKn to SHKn+7 of a comparison target row (different row of a same color) (for example, row H shown in FIGS. 2 and 3) is performed for the total nozzles.

FIGS. 8A and 8B show the process of Step S140 for comparing the reference nozzles SHKn to SHKn+7 in the reference row with the comparison nozzles SHKn to SHKn+7 of the same number in a different row of a same color. The adjacent nozzle missing determining process for nozzles SHK in the reference row and nozzles of a same number in a different row of a same color, as shown in FIG. 8A, nozzles SHKn to SHKn+7 corresponding to the reference row (row A) and the different row of a same color (row H) are read in, and both nozzles are compared with each other. In the start of the process for a case where n=1, the comparison nozzles SHK1 to SHK8 in the different row of a same color (row H) are read in, and as shown in FIG. 8B, a logical multiplication operation (AND operation) is performed for the reference nozzles SHK1 to SHK8 in the reference row (row A) and the comparison nozzles SHK1 to SHK8 in the different row of a same color (row H). As the result of the AND operation, for example, the result of determination on the adjacent nozzle missing shown in FIG. 8B is acquired. Here, the result of determination on the adjacent nozzle missing shows the adjacent nozzle missing in which the nozzles (in the example of FIG. 8B, nozzles A#1 and H#1) in the reference row (row A) and the comparison target row (row H) corresponding to the position of the bit having a value of “1” have dot missing together. However, in the adjacent nozzle missing determining process according to this embodiment, it is only determined whether there is the adjacent nozzle missing, and thus the position of the adjacent nozzle missing is not determined. In addition, when a configuration in which a plurality of the caps 32 is included is used, it may be configured that at least one cap that is needed for cleaning the adjacent nozzles is capped by determining the position of the adjacent nozzle missing and a partial cleaning process is performed.

In Step S150, when there is a different row of a same color, the flag F for a different row of a same color is set to “1”, so that it can be checked in a process thereafter. When the flag F for a different row of a same color is “1”, in the process of Steps S160 to S200 described below, a comparing process is performed for both cases where the comparison target row is the same row and where the comparison target row is the different row of a same color. On the other hand, when F=0 (for a record head not having a different row of a same color), in the process of Steps S160 to S200, a comparing process is performed only for a case where the comparison target row is the same row. By preparing the flag F, this program can respond to a record head of a zigzag disposition nozzle-type having the same row and a different row of a same color and a record head of a nozzle type not having a different row of a same color.

In Step S160, whether the reference nozzles are SHK1 to SHK8 is determined. In this time for a case where n=1, the reference nozzles are SHK1 to SHK8, and accordingly, the process proceeds to Step S170. Then, it is determined whether the reference nozzles are #1 to #8. In this time for a case where the process for the first test block (test of nozzles #1 to #45) is performed, the reference nozzles are #1 to #8, and accordingly, the process proceeds to Step S180. Then, the reference nozzles SHK1 to SHK8 are compared with SHK180 and SHK1 to SHK 7 of the comparison nozzles #180 and #1 to #7.

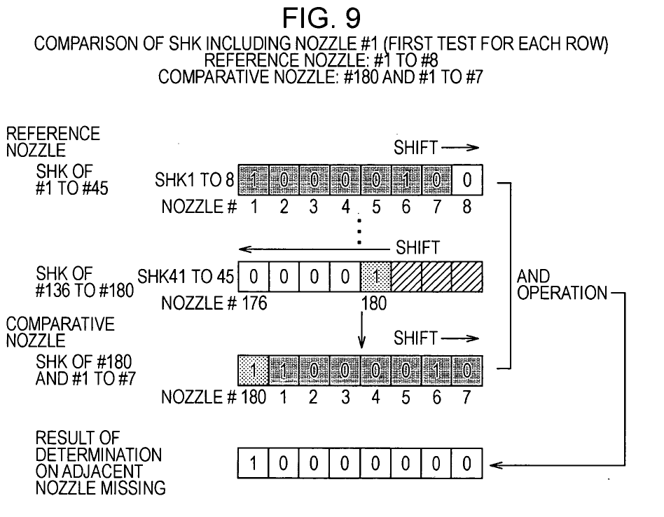

FIG. 9 shows the process of Step S180 in which a comparing process for the SHK including the reference nozzle #1 in the first test block is performed. The reference nozzles #1 to #8 and the comparison nozzles #180 and #1 to #7 are compared with each other. First, comparison nozzle data to be compared with the reference nozzles SHK1 to SHK8 of the first test block (SHK of #1 to #45) is generated. In other words, as shown in FIG. 9, the data of the reference nozzles SHK1 to SHK8 is bit-shifted to the right side (the direction in which the nozzle number increases) by one bit. In addition, data of the nozzles SHK41 to SHK45 of the fourth test block (SHK of #136 to #180) is bit-shifted to the left side (the direction in which the nozzle number decreases) by four bits. Then, the SHK of the comparison nozzles #180 and #1 to #7 is acquired by performing a logical sum operation (OR operation) between both bit rows (an 8-bit (one byte) bit row of one row) after the bit shift. Then, a logical multiplication operation (AND operation) is performed between the SHK of the comparison nozzles #180 and #1 to #7 and the reference nozzle SHK1 to SHK8 of the first test block (SHK of #1 to #45). As the result of the AND operation, for example, the result of determination on the adjacent nozzle missing shown in FIG. 9 is acquired. For example, when there is a value of “1” in the result of determination on the adjacent nozzle missing, it is determined that there is the adjacent nozzle missing.

In this example in which the flag F for the different row of a same color is “1”, a comparing process is performed with the different row (row H) of a same color used as the comparison target row. In such a case, the bit shifting process and the logical sum operation, which are the same as those for the same row, is performed for the nozzles SHK1 to SHK 8 of the first test block in the different row (row H) of a same color and the nozzles SHK41 to SHK45 of the fourth test block in the different row (row H) of a same color in FIG. 9 and SHK of the comparison nozzles #180 and #1 to #7 in the different row (row H) of a same color is acquired. Then, by performing an AND operation of the reference nozzles SHK1 to SHK 8 of the reference row (row A) and SHK of the comparison nozzles #180 and #1 to #7 in a different row of a same color, the result of determination on the adjacent nozzle missing is acquired.

Then, in Step S210, it is determined whether there is adjacent nozzle missing. When there is adjacent nozzle missing, it is stored in Step S240, and the process ends. On the other hand, when there is no adjacent nozzle missing (negatively determined in S210), it is determined whether the test for the total nozzles (8 rows×45 nozzles) is completed (Step S220). For example, when n=41, it is determined that the test (adjacent nozzle missing test) for the total nozzles of the test block is completed. On the other hand, when n=1, the test for the total nozzles is not completed (negatively determined in S220), and thus, the process proceeds to Step S230. Then, in Step S230, it is set that n=n+8 (n=9), then, the process proceeds back to Step S120. Then, the processes (that is, a comparing process between the reference nozzles SHK9 to SHK16 and comparison nozzles SHK9 to SHK16 of the same number in a different row of a same color and the like) of Steps S120 to S150 for a case where n=9 are performed. In addition, at the second time and thereafter (n>9), F=1, and thus, Steps S130 and S150 can be omitted.

Next, in Step S160, since it is determined that the reference nozzles are not SHK1 to SHK8 (in this number of times, the reference nozzles are SHK9 to SHK16), the process proceeds to Step S190. Then, the reference nozzles SHKn to SHKn+7 are compared with the comparison nozzles SHKn−1 to SHKn+6 as one byte data. In other words, in Step S190, when the reference nozzle SHK is SHK (that is, the bit row SHK in the second row and thereafter in each test block) that does not include SHK1, a comparing process between the reference nozzles and the comparison nozzles SHK having the number of “reference nozzle number−1” is performed.

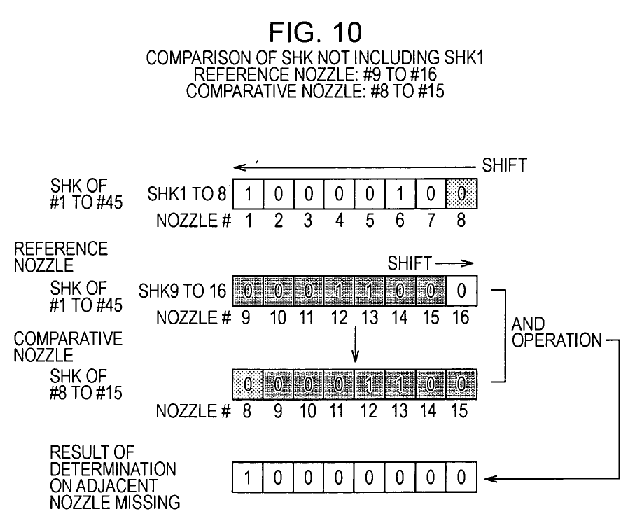

FIG. 10 shows the comparing process of Step S190. The reference nozzles #9 to #16 and comparison nozzles #8 to #15 having numbers of “the number of the reference nozzle−1” are compared with each other. First, comparison nozzle data to be compared with the reference nozzles SHKn to SHKn+7 (here, n>2) is generated. In other words, as shown in FIG. 10, data of the nozzles SHK1 to SHK8 of the first test block (SHK of #1 to #45) is bit-shifted to the left side (the direction in which the nozzle number decreases) by 7 bits. In addition, data of the nozzles SHK9 to SHK16 of the first test block (SHK of #1 to #45) is bit-shifted to the right side (the direction in which the nozzle number increases) by one bit. Then, a logical sum operation (OR operation) between both the bit rows after the bit shift is performed so as to acquire one byte data SHK of the comparison nozzles #8 to #15. Then, a logical multiplication operation (AND operation) is performed between the reference nozzles SHK9 to SHK16 of the first test block (SHK of #1 to #45) and SHK of the comparison nozzles #8 to #15. As the result of the AND operation, for example, the result of determination on adjacent nozzle missing shown in FIG. 10 is acquired.

In this example in which the flag F for the different row of a same color is “1”, a comparing process in which the different row (row H) of a same color is the comparison target row is performed. In this case, for the nozzles SHK1 to SHK8 of the first test block in the different row (row H) of a same color and the nozzles SHK9 to SHK16 of the first test block in the different row (row H) of a same color, the bit shifting process and the logical sum operation, which are the same as those performed for the same row in FIG. 10, are performed so as to acquire SHK of the comparison nozzles #8 to #15 in the different row (row H) of a same color. Then, an AND operation between the reference nozzles SHK9 to SHK16 of the reference row (row A) and SHK of the comparison nozzles #8 to #15 in the different row of a same color is performed so as to acquire the result of determination on adjacent nozzle missing.

Then, when there is no adjacent nozzle missing (negatively determined in S210) and the test for the total nozzles of the test block is not completed (negatively determined in S220), it is set that n=n+8 (S230). Then, the processes of S120 to S160, S190, and S210 to S230 are repeatedly performed unless it is determined that there is adjacent nozzle missing in S210 until the processes end for a case where n=41. As a result, a comparing process between the reference nozzles SHK 17 to SHK45 in the reference row and the comparison nozzles SHK17 to SHK45 of a same number in the different row of a same color is performed (S140), and comparing processes among the reference nozzles SHK17 to SHK45 in the reference row, the comparison nozzles SHK17 to SHK45 having numbers of “the number of the reference nozzle−1” in the same row, and the comparison nozzles SHK17 to SHK45 having numbers of “the number of the reference nozzle−1” in the different row of a same color are performed (S190). Accordingly, when the test for the total nozzles of the test block is completed (positively determined in S220), the adjacent nozzle missing determining process of the first-time test blocks (nozzles #1 to #45) ends.

Thereafter, an adjacent nozzle missing determining process for the second test block (nozzles #46 to #90) is started. The comparing process (S140) between the reference nozzles in the reference row of the second test block and comparison nozzles of same numbers in the different row of a same color is performed in the same manner as in the first test block. Thereafter, in the determining processes of S160 and S170, when n=1, the reference nozzles are SHK1 to SHK8 (positively determined in S160). However, in the case, the reference nozzles are not #1 to #8 (negatively determined in S170), and thus, the process proceeds to Step S200.

In Step S200, a comparing process between the reference nozzles SHK1 to SHK8 and the comparison nozzles having numbers of “the number of the reference nozzle−1” is performed. Since #45 having the number of “the reference nozzle #46−1” has been tested as the previous test block, a comparing process is performed for the nozzle SHK45 of the previous test (previous test block) and the comparison nozzles SHK 1 to SHK 7 of the current test (current test block) as one byte data. In other words, in Step S200, in the second test block and thereafter, the comparison nozzle data is generated by using the nozzle SHK45 of the previous test block and the nozzles SHK1 to SHK7 of the current test block for comparing the one byte data SHK of the reference nozzle including SHK1 with the comparison nozzle SHK having the number of “the number of the reference nozzle−1”. Then, the reference nozzles SHK1 to SHK8 are compared with the comparison data.

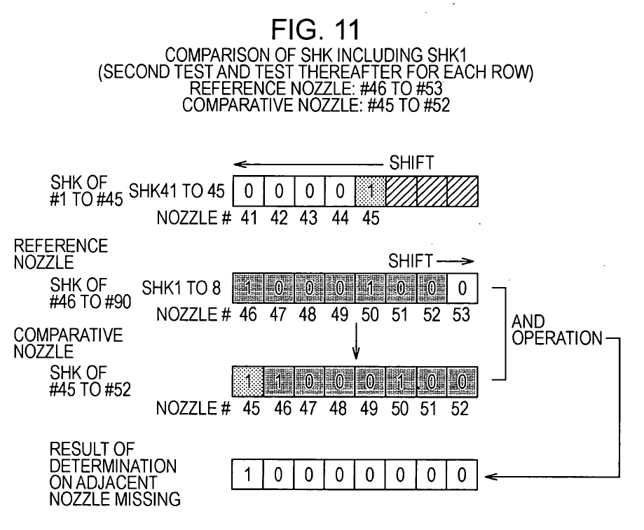

FIG. 11 shows the comparing process of Step S200. The reference nozzles #46 to #53 and comparison nozzles #45 to #52 having numbers of “the number of the reference nozzle−1” are compared with each other. First, comparison nozzle data to be compared with the reference nozzles SHK is generated. In other words, as shown in FIG. 11, data of the nozzles SHK41 to SHK45 of the first test block (SHK of #1 to #45) is bit-shifted to the left side (the direction in which the nozzle number decreases) by 4 bits. In addition, data of the nozzles SHK1 to SHK8 of the second test block (SHK of #46 to #90) is bit-shifted to the right side (the direction in which the nozzle number increases) by one bit. Then, a logical sum operation (OR operation) between both the bit rows after the bit shift is performed so as to acquire one byte data SHK of the comparison nozzles #45 to #52. Then, a logical multiplication operation (AND operation) is performed between the reference nozzles SHK1 to SHK8 of the second test block (SHK of #46 to #90) and SHK of the comparison nozzles #45 to #52. As the result of the AND operation, for example, the result of determination on adjacent nozzle missing shown in FIG. 11 is acquired.

In this example in which the flag F for the different row of a same color is “1”, a comparing process in which the different row (row H) of a same color is the comparison target row is performed. In this case, for the nozzles SHK41 to SHK45 of the first test block (SHK of #1 to #45) in the different row (row H) of a same color and the nozzles SHK1 to SHK8 of the second test block (SHK of #46 to #90) in the different row (row H) of a same color, the bit shifting process and the logical sum operation, which are the same as those performed for the same row in FIG. 11, are performed so as to acquire SHK of the comparison nozzles #45 to #52 in the different row (row H) of a same color. Then, an AND operation between the reference nozzles SHK1 to SHK8 of the reference row (row A) and SHK of the comparison nozzles #45 to #52 in the different row of a same color is performed so as to acquire the result of determination on adjacent nozzle missing.

At the number of times n=9 and thereafter, after the comparing process (S140) between the reference nozzles and comparison nozzles of same numbers in the different row of a same color is performed, the reference nozzles are not SHK1 to SHK8 (negatively determined in S160), and thus, the process proceeds to Step S190. Then, the comparison nozzle data is generated by performing the bit shifting process and the OR operation that are shown in FIG. 10, and a comparing process between the reference nozzles SHKn to SHKn+1 and the comparison nozzles SHKn−1 to SHKn+6 having numbers of “the number of the reference nozzle−1” as one byte data is performed. Then, when this process is completed until n=41, comparing processes of the reference nozzles SHK17 to SHK45 in the reference row, the comparison nozzles SHK16 to SHK44 having numbers of “the number of the reference nozzle−1” in the same row, and the comparison nozzles SHK 16 to SHK 44 having numbers of “the number of the reference nozzle−1” in the different row of a same color are performed. Accordingly, when the test for the total nozzles of the test block is completed (positively determined in S220), the adjacent nozzle missing determining process for the second test block (nozzles #46 to #90) is completed. Hereinafter, similarly, the adjacent nozzle missing determining process for the third and fourth test blocks is performed in the same manner as in the second test block. Accordingly, in the third and fourth test blocks, as in the second test block, when initially n=1, a comparing process for SHK 45 of the previous test and SHK1 to SHK7 of the current test as one byte data is performed (S200).

In the middle of the process until the adjacent nozzle missing determining process for the fourth test block is completed, when it is determined that there is adjacent nozzle missing (positively determined in S210), the adjacent nozzle determining process at the time point of the determination is completed, and the process proceeds to Step S40 shown in FIG. 12. In this case, since it is determined that there is the adjacent nozzle missing in Step S40, the cleaning strength corresponding to the total number of the nozzle missing detections is acquired by referring to a cleaning strength setting table based on the total number of nozzle missing detections that are counted based on the test result data of the total nozzles (8 rows×180 nozzles) of the record head 19 (S50). Then, the maintenance device 30 is driven at the acquired cleaning strength for performing the cleaning operation. In addition, the process for reading the comparison nozzle SHK in Step S140 and the process for reading the nozzle SHK used for generating the comparison nozzle data in Steps S180 to S200 are performed by the comparison data acquiring section 54, and the bit shifting process for the nozzle SHK is performed by the bit shifter 55.

Although an example for the band print mode has been described with reference to FIG. 12, in the adjacent nozzle missing determining process for the interlaced print mode, the positional relationship of nozzles (near nozzles and distant nozzles) corresponding to neighbor two dots (continuous two dots) or two missing dots with one dot interposed therebtween is uniquely determined in accordance with the print mode. Accordingly, only the nozzle numbers of the reference nozzles and the comparison nozzles are different, and thus, the comparison nozzle data corresponding to the interlaced print mode for the reference nozzle SHK is generated by performing a predetermined process including the bit shifting process, the OR operation, and the like. Then, a comparing process for the comparison nozzle data and the reference nozzle SHK is performed. Alternatively, instead of performing the predetermined process including the bit shifting process, the OR operation, and the like, a method in which a comparison nozzle number satisfying the positional relationship of adjacent nozzles corresponding to the number of the reference nozzle is acquired by referring to an adjacent nozzle number table that is stored in the non-volatile memory 45 in advance, and the test result data corresponding to the comparison nozzle number is sequentially read from a predetermined storage area of the RAM 43 or the register R so as to generate one-byte data SHK for the comparison nozzle may be used. The comparison data generating unit is configured by the bit shifter 55 that performs the bit shifting process described with reference to FIGS. 9 to 11 and the operation section of the control unit 41 that performs a logical sum operation for two bit rows after bit shift. In addition, the comparison bit row (comparison nozzle data) may be generated by bit-shifting one bit row or by bit-shifting a plurality of bit rows of three or more and performing a predetermined operation among three or more bit rows after bit shift.

In the band printing process, printing is started without performing the cleaning operation even in a case where there is the adjacent nozzle missing in the interlaced print mode. On the other hand, in the interlaced printing process, printing is started without performing the cleaning operation even in a case where there is the adjacent nozzle missing in the band print mode.

As described above in detail, according to this embodiment, the following advantages can be acquired.

(1) Whether there is adjacent nozzle missing corresponding to neighbor two dots or two dots with another dot interposed therebetween can be determined in accordance with the print mode. In other words, even when two nozzles having the positional relationship of neighbor two dots or two dots with another dot interposed therebtween is not the positional relationship of neighbor dots or two dots with another dot interposed therebtween on the nozzle opening face 19A of the record head 19, whether there is nozzle missing that causes the adjacent dot missing can be accurately determined.
(2) The cleaning operation (recovery operation) is configured to be performed by the maintenance device 30 in a case where it is determined that there is adjacent nozzle missing. Accordingly, in a case where dot missing is scattered and does not adversely affect the print quality, the cleaning operation may not be performed. As a result, in a case where there is nozzle missing that does not have influence on the print quality, the cleaning operation is not performed, and thereby the frequency of performing the cleaning operation can be decreased. Accordingly, the amount of consumption of ink that is consumed for a process other than the printing process can be suppressed to be small, and thereby, the number of printable sheets per one ink cartridge can be increased.
(3) The nozzle testing is performed in advance before start of a printing process, for example, at the start of operating the printer or at a time point when the printer is in a standby state, and, in the printing process, adjacent nozzle missing determining process corresponding to the print mode at that time is performed by using the print result data. Accordingly, the delay of start of the printing process can be avoided, compared to a configuration in which the nozzle testing is performed after the printing process is directed to be performed.
(4) A configuration in which the test result data is read (S120) in the adjacent nozzle missing determining process and a comparing process for the test result data of the reference nozzle and the test result data of comparison nozzles in the different row of a same color (S140) and in the same row (S180 to S200) is performed together is used. Accordingly, the test result data of the reference nozzle is commonly used, and thereby the number of times of reading the test result data of the reference nozzles in the adjacent nozzle missing determining process can be decreased. For example, the number of times of reading the test result data of the reference nozzles can be decreased by half, for example, compared to a case where the test result data of the reference nozzles in the same row and in the different row of a same color is separately read for performing the determination process. As a result, a high-speed adjacent nozzle missing determining process can be implemented.
(5) The test for the total nozzles (180 nozzles) are sequentially performed for a plurality of test blocks, the test result data for each test block (45 nozzles) is stored in a six-row register (8 bits×6 rows=48 bits) formed by N bytes (Here, N is a natural number. However, in this embodiment N is one byte), and, in the last row (sixth row) of each test block, only a part of the data may be stored. Even in such a case, the comparison nozzle data in which the test result data of the comparison target is disposed in a storage position to be compared with the test result data of the reference nozzle is generated by bit-shifting the test result data by using the bit shifter 55 and performing a logical sum operation between two bit rows acquired by shifting the bits. Accordingly, as shown in FIG. 11, the adjacent nozzle missing determining process can be performed by processing a simple operation of a logical multiplication operation (comparing process) of the test result data of the reference nozzle and the comparison nozzle data. In addition, the comparing process can be performed between two nozzles #1 and #180 that are spaced from each other while the two dots are two dots with another dot interposed therebtween or neighbor dots.

In addition, an embodiment of the invention is not limited to the above-described embodiment and may be changed as below.

### Modified Example 1

In the above-described embodiment, the cleaning operation is performed immediately in a stage in which there is adjacent dot missing once. However, the cleaning process may be performed in a stage in which the number of times of adjacent dot missing reaches a predetermined value (>2) or the number of times of adjacent dot missing satisfies a predetermined condition based on the result of determination for all the combinations of adjacent nozzles. In such a case, the cleaning strength may be determined based on the number of times of adjacent dot missing.

### Modified Example 2

In the above-described embodiment, the adjacent nozzle missing is determined in accordance with the print mode that is determined based on the print data. However, the determination on the adjacent nozzle missing may be performed for all the print modes employed in the printer. For example, the determination on the adjacent nozzle missing may be performed for all the print modes (all the record modes) including both the band print mode and the interlaced print mode. In such a case, the adjacent nozzle missing determining process can be performed in advance before performing a printing process, and the cleaning operation is performed only when there is the adjacent nozzle missing. Accordingly, an unnecessary cleaning operation, for example, for a case where there is nozzle missing scattered in all the print modes and there is no adjacent nozzle missing can be avoided. In addition, in this case, a configuration in which it is determined whether there is adjacent nozzle missing satisfying a cleaning condition for a print mode acquired from the print data in a printing process by using the result of determination on the adjacent nozzle missing process for all the print modes which is performed in advance before the printing process may be used.

### Modified Example 3

The acquisition of the print mode may not be based on the print data. For example, the print mode of the previous printing process is stored in a memory, and the print mode may be used for the adjacent nozzle missing determining process. In addition, print mode information that has been used in a plurality of past printing processes is accumulated in the memory, and a print mode having the highest frequency of adoption may be used for the adjacent nozzle missing determining process by using a statistical technique. In addition, a record mode (for example, the interlaced print mode) corresponding to a high-quality print mode in which existence of the adjacent dot missing in the printed image is not particularly preferable may be used for the adjacent nozzle missing determining process. In addition, a configuration in which the print mode for the adjacent nozzle missing determining process is designated to the printer by user's operating an input device may be used. In such cases, since the adjacent nozzle missing determining process can be performed in advance before the printing process, a waiting time for start of the printing process can be shortened, compared to the configuration of the above-described embodiment in which the adjacent nozzle missing determining process is performed all the time when the printing process is started. Here, in a case where a print mode is predicted by using a statistical technique or the like, when a printing process in a print mode different from the employed printed mode in the adjacent nozzle missing determining process is directed thereafter, it is preferable that the adjacent nozzle missing determining process is performed in the print mode of the printing process again. In addition, when a print mode of the printing process thereafter can be determined in advance in accordance with user's input for designation of the print mode or the like, before the printing process is started, for example, at the start of operation of the printer or at a time when the printer is in a standby state, both the dot missing determining process and the cleaning operation can be performed in advance, and thereby delay of start of the printing process cannot occur easily.

### Modified Example 4

After the print data is received, the nozzle test and the adjacent nozzle determining process corresponding to the print mode may be performed. Under such a configuration, although a waiting time for start of the printing process is needed, however, high-quality printing without visually distinguished dot missing can be performed.

### Modified Example 5

The test target nozzles are not limited to the total nozzles. For example, only a group of nozzles located in a predetermined area including a nozzle having a high frequency of predetermined nozzle missing may be set as the test target nozzles based on the test result data of the nozzle test in the past by using a statistical technique. In such a case, a time required for the test can be shortened without decreasing the accuracy of the nozzle test much. In addition, when the nozzle test is performed after the print data is received, it may be configured that only color nozzles are set as the test targets in a case where a color printing process is performed, and only black nozzles are set as the test targets in a case where a monochrome printing process is performed.

### Modified Example 6

In the above-described embodiment, the total test target nozzles are divided into a plurality of test blocks for the test. However, the total test target nozzles may be tested by performing a test process once.

### Modified Example 7

In the above-described embodiment, a record head having two nozzle rows (the same row and the different row having a same color) of a same color is employed. However, a record head having only one nozzle row of a same color may be used. In such a case, the nozzles positioned in the same row are compared with each other. Furthermore, a record head having three nozzle rows, four nozzle rows, or more of a same color may be used. In such a case, there is a plurality of the comparison target rows to be compared with the reference row.

### Modified Example 8

In the above-described embodiment, the invention is applied to a serial printer of an ink jet recording type. However, the invention may be applied to a line printer of an ink jet recording type. For example, the line printer has a configuration in which a plurality of nozzle rows having different nozzle positions in the paper width direction (the direction intersecting the paper transport direction) is arranged in a plurality of rows in the transport direction in a state in which the nozzles are distributed to fill the paper width. Accordingly, as combinations of nozzles corresponding to the group of dots missing, there are the same row and the different row of a same color.

### Modified Example 9

The missing of a plurality of nozzles to be determined is not limited to the adjacent nozzle missing. In other words, missing of a group of dots that defines missing of a plurality of dots is not limited to the two dots missing with another dot interposed therebetween and the continuous two dots missing. For example, only one of these may be used. In addition, the missing of a group of dots may be continuous Q (here, Q is a natural number satisfying the condition of Q>3) dots missing such as continuous three dots missing, continuous four dots missing, continuous five dots missing, or the like or a plurality of dots missing with another dot or a plurality of other dots interposed therebetween such as two dots missing with two or three other dots interposed therebetween, three dots missing (among these, two dots are next to each other) with one or two dots interposed therebetween. In addition, here, “continuous” of the continuous Q dots includes a form in which a plurality of dots belonging to one row is continuously disposed to be next to each other in the one row such as Q dots forming the shape of one line (for example, the shape of a bar “−” or the shape of a wave “˜”), the shape of two rows (for example, the shape of adjacent two bars “=” or a cross shape “+” or “×”) or densely disposed Q dots (for example, the shape of densely disposition of a triangular lattice or a rectangular lattice) (however, dots corresponding to the same nozzle is one). In addition, one or a plurality of the above-described types of dot missing may be used. In addition, nozzle missing in which all the combinations of nozzles having predetermined positional relationship for forming missing of at least one type of missing of a group of dots are the non-ejection nozzles (defective nozzles) is determined based on the test result data for each combination of nozzles having the predetermined positional relationship.

### Modified Example 10

The nozzle testing device is not limited to use the test method of the above-described embodiment. For example, a test method in which dot missing is detected by printing test (nozzle checking) patterns on a test sheet from test target nozzles by ejecting ink droplets and by analyzing image data acquired from reading the test print material by using an image reading device (a CCD camera or the like) may be used.

### Modified Example 11

The recovery operation performed for the nozzles in a case where the adjacent nozzle missing is determined is not limited to the cleaning operation for forcedly discharging ink from the nozzles. For example, the recovery operation may be air ejection (flushing) for ejecting ink droplets regardless of a printing process by driving the record head 19 so as to remove ink, which has increased viscosity, or the like inside the nozzles. In such a case, the maintenance unit is configured by the head control units 47 to 50, the ejection element 38, and the like that are controlled by the control unit 41 for the air ejecting operation.

### Modified Example 12

In the above-described embodiment, the liquid ejecting apparatus is embodied as in ink jet recording apparatus. However, the invention is not limited thereto. Thus, the invention may be embodied as a liquid ejecting apparatus that ejects liquids (including a liquid, a liquid-form body that is formed by dispersing or mixing particles of a function material into a liquid, a fluid-form body such as gel, and solid that can flow as fluid to be ejected) other than ink. For example, the liquid ejecting apparatus may be a liquid-form body ejecting apparatus that ejects a liquid-form body containing a material such as an electrode material or a coloring material (pixel material) used for producing a liquid crystal display, an EL (electroluminescence) display, a field emission display, or the like in a dispersed or dissolved form, a liquid ejecting apparatus that ejects a bioorganic material used for producing a bio chip, or a liquid ejecting apparatus that ejects a liquid that is used as a precision pipette and becomes a test material. In addition, the liquid ejecting apparatus may be a liquid ejecting apparatus that ejects a lubricant to a precision machine such as a clock or a camera in a pin-point manner, a liquid ejecting apparatus that ejects a transparent resin solution such as an ultraviolet-curable resin onto a substrate for forming a tiny hemispherical lens (optical lens) used in an optical communication element or the like, a liquid ejecting apparatus that ejects an acid or alkali etching solution for etching a substrate or the like, or a fluid ejecting device that ejects a fluid-form body such as gel (for example, physical gel), or a particulate ejecting apparatus (for example, a toner-jet type recording apparatus) that ejects solid, for example, a power (particulate) such as toner. In addition, the invention may be applied to any one type of the these fluid ejecting apparatuses. In descriptions here, a fluid does not include a fluid formed by only vapor. In addition, the fluid includes, for example, a liquid (inorganic solution, organic solution, liquid solution, liquid resin, liquid metal (metal melting solution), or the like), a liquid-form body, a fluid-form body, a particulate (including a particle and power), and the like. In addition, the above-described substrate or the precision machine becomes the target thereof.

What is claimed is:

1. A nozzle missing determining device that determines a nozzle missing state of a liquid ejecting apparatus including an ejection unit having a plurality of nozzles, the nozzle missing determining device comprising:
a test unit that acquires test result data by performing a test for detecting a non-ejection nozzle from among test target nozzles of the ejection unit;
a mode determining unit that determines a record mode at a time when the ejection unit performs a record operation by ejecting a liquid to a target; and
a nozzle missing determining unit that determines whether all the nozzles having predetermined positional relationship are non-ejection nozzles based on the test result data,
wherein the predetermined positional relationship includes positional relationship of nozzles of which dots that are formed by a same type of liquid are next to each other, and
wherein the nozzle missing determining unit performs the determination for each combination of the nozzles having the predetermined positional relationship which is determined in accordance with the determined record mode.

2. The nozzle missing determining device according to claim 1, further comprising a data storing unit in which each N-byte bit row of the test result data acquired from testing the test target nozzles by using the test unit is stored,
wherein the nozzle missing determining unit includes:
a comparison data generating section that generates a comparison bit row in which the test result data of the nozzles having the predetermined positional relationship is disposed in a same bit position for one of the bit rows as a reference bit row by bit-shifting data of at least one of the bit rows which are stored in the data storing unit;
a comparing operation section that performs a comparing operation for the reference bit row and the comparison bit row; and
a determination section that determines missing of a group of the nozzles based on the operation result of the comparing operation section.

3. The nozzle missing determining device according to claim 2,
wherein the test unit repeats a test operation for each unit for test that is acquired from dividing the test target nozzles into a plurality of groups in the direction of the nozzle row and stores the each N-byte bit row of the test result data for the each unit for test in the data storing unit, and
wherein, when the reference bit row includes the test result data of an end part nozzle located in an end part of the unit for test, the comparison data generating section generates the comparison data bit row by bit-shifting data of one bit row of comparison target rows in the same unit for test as that of the reference bit row and data of a bit row in the different unit for test that is adjacent to the one bit row and performing a logical OR operation for two bit rows after the bit shift.

4. The nozzle missing determining device according to claim 3,
wherein the ejection unit includes a plurality of nozzle rows for one type of liquid,
wherein the nozzle missing determining unit is configured to perform a same-nozzle row determination operation for determining whether there is nozzle missing in which all the nozzles having the predetermined positional relationship are non-ejection nozzles in a same nozzle row of the plurality of nozzle rows of the same type of liquid and a different-nozzle row determination operation for determining whether there is nozzle missing in which all the nozzles having the predetermined positional relationship are non-ejection nozzles in different nozzle rows of the plurality of nozzle rows of the same type of liquid,
wherein the test unit further includes a data storing section in which each N-byte bit row of the test result data acquired from testing the test target nozzles by using the test unit is stored, and
wherein the nozzle missing determining unit performs the same-nozzle row determination operation and the different-nozzle row determination operation by using a common reference bit row, by performing a comparing operation for the common reference bit row and the comparison bit row each time one bit row to be used as a reference corresponding to the reference nozzle row is read from the data storing unit in generating a comparison bit row used for performing the same-nozzle row determination operation corresponding to the reference bit row and a comparison bit row used for performing the different-nozzle determination operation.

5. A liquid ejecting apparatus comprising:
an ejection unit having a plurality of nozzles that can eject a liquid to a target;
a maintenance unit that performs a recovery operation for recovering ejection performance of the plurality of nozzles of the ejection unit; and
a nozzle missing determining device according to claim 1,
wherein, when the nozzle missing determining unit configuring the nozzle missing determining device determines that at least one combination from among combinations of the nozzles having the predetermined positional relationship has nozzle missing, the maintenance unit performs the recovery operation for the ejection unit.
